(19) United States
(12) Patent Application Publication
(10) Pub. No.: US 2005/0050559 A1
(43) Pub. Date: Mar. 3, 2005

(54) Electronic device provided with rack and pinion

(76) Inventors: Taizo Minowa, Fukui (JP); Tomoyuki Harada, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 10/923,884

(22) Filed: Aug. 24, 2004

(30) Foreign Application Priority Data
Aug. 27, 2003 (JP) 2003-208983

(51) Int. Cl. G11B 17/03; G11B 17/04

(52) U.S. Cl. 720/607

(57) ABSTRACT

To provide an electronic device having a rack and a pinion which reliably eliminates a backlash, and which is free from the occurrence of a delay of an operation during the rotation of the pinion, the rack is made of an elongated plate type base portion, and a plurality of teeth stood up in an inclined state at one side section of the base portion with a uniform pitch and formed integrally out of a flexible material. The teeth of the pinion are formed vertically so that the inclined teeth of the rack stand up substantially vertically and bend rearward when the teeth of the pinion are meshed with those of the rack.

### BACKGROUND OF THE INVENTION

1. Field of the Invention

The present invention relates to a reciprocatingly sliding feed unit for various kinds of electronic devices, toys, timepieces and other kinds of precision machines, and more particularly to an electronic device provided with a rack and a pinion constituting such a feed unit as mentioned above.

2. Related Art

In a reciprocatingly sliding feed unit uses in many cases a mechanism formed so that a rack and a pinion are meshed with each other. For example, in a disk device, a rack-pinion mechanism is used as a mechanism for withdrawing and inserting a tray from and into the disk device. In a traverse unit provided with a turntable on which a disk is mounted, an optical pickup is fixed thereto. The optical pickup has to be moved at a predetermined speed in accordance with a rotation of the disk, and a speedy and accurate movement of the optical pickup to a predetermined data position is demanded. A rack-pinion mechanism is employed as an optical pickup moving device, and, especially, the positioning accuracy of this device is important.

In a rack-pinion mechanism, a pinion is meshed with the teeth of a rack arranged linearly with a predetermined pitch and the rotation of the pinion enables the rack to slide. Between the teeth of the rack and those of the pinion meshed with one another, a backlash occurs due to slight clearances. This backlash lowers the position accuracy of the reciprocatingly moving rack. Unless the optical pickup is moved correctly by the rotation of the pinion, accurate recording and reproduction of information becomes unable to be carried out. Moreover, it becomes impossible to move the optical pickup speedily to a predetermined data position accurately. In view of such inconveniences, various measures have heretofore been taken so as to prevent the occurrence of a backlash mentioned above.

For example, in “PICKUP FEED MECHANISM FOR DISK PLAYERS” disclosed in JP-A-2002-25206, a first rack gear, and a second rack gear disposed in parallel with the first rack gear in a position spaced from the first rack gear are connected together by a pair of mutually parallel elastic plates stood up diagonally in longitudinally spaced positions. The phase of the teeth of the first rack gear and that of those of the second rack gear are staggered from each other. When the teeth of the pinion are inserted between those of the first and second rack gears, the spaces between the teeth are forcibly widened due to the pivotal deformation of the elastic plates. Namely, owing to the urging force of the elastic plates, the teeth of the pinion receive a pressure, which occurs due to a joint operation of the teeth of the first and second racks, and are held in a backlash-less condition and can be rotated smoothly.

However, in the above-described method, a space is needed for connecting the upper and lower rack gears with the elastic plates, so that the thickness of the rack increases. The face width of the pinion meshed with the two rack gears also increases to cause the dimensions of the apparatus as a whole to increase. As a result, a metal mold for making the rack gears and elastic plates integral becomes complicated, so that the manufacturing cost increases. Moreover, since the connecting portions between the rack gears and elastic plates are thin, there is the possibility that the connecting portions be broken when the rack gears and elastic plates are incorporated into a disk device, and the productivity lowers.

In general, the parts constituting a disk device are manufactured separately in an outside molding factory in many cases. Since there are cases where such parts are deformed or broken during transportation thereof from a molding factory to an assembling factory, the reliability of the parts is low. There are also cases where a scatter of an angle of inclination between rack gears and elastic plates occurs to fail in obtaining a backlash removing effect after an assembling operation finishes.

The “PRECISION DRIVING DEVICE” disclosed in JP-U-54-18572 is a precision driving device including a pinion and a rack in which the rack having a toothed portion meshed with the pinion, and a base portion supporting the toothed portion via curved elastic sections formed at both ends of the rack are molded out of a synthetic resin so that the toothed portion and based portion become integral. This device is formed so that the adhesion of the toothed portion and pinion is maintained owing to the elastic deformation of the elastic sections before the toothed portion is bent due to a force exerted on a part thereof.

When the teeth of the pinion are pressed against the toothed portion of the rack in this precision driving device, the elastic sections of the rack is bent toward the base portion. Therefore, a backlash of the teeth of the pinion can be eliminated, and a stable power transmission can be attained without causing a rattling between gears. Since a backlash is removed, the teeth of the pinion and rack are kept in a contacting state at all times, and the occurrence of noise between the gears is prevented. Furthermore, since the elastic sections are provided in a curved state at both end of the rack, a good effect can be obtained, i.e., the meshed condition of the pinion with respect to the rack over the whole length of the latter can be excellently maintained.

Although the removing of a backlash in the direction of the thickness of the teeth can be done owing to the deformation of the elastic sections supporting the toothed portion, the removing of a backlash in the direction of the face width of the pinion and in the direction in which the teeth are arranged cannot be sufficiently done. Moreover, since the toothed portion is supported on the elastic sections to be deformed elastically, a delay of a movement of the rack in accordance with the rotation of the pinion occurs in some cases, so that it cannot be said that the driving and positioning accuracy of the apparatus is high. Since the device formed so that a load is imparted to the elastic sections at all times, the fatigue failure thereof becomes a problem, and the durability of the rack lowers.

### SUMMARY OF THE INVENTION

Thus, a related art rack has such problems as mentioned above. What the present invention aims to solve these problems. An object of the present invention is to provide an electronic device provided with a rack and a pinion, having a simpler construction, capable of reliably preventing the occurrence of a backlash and meshing noise of gears, and not encountering a delay of a movement of a rack made by the rotation of a pinion.

In the electronic device provided with a rack and a pinion according to the present invention, the rack includes an elongated plate type base portion, and a plurality of teeth stood up in an inclined state at one side section of the base portion with a predetermined pitch, the base portion and teeth being formed integrally out of a flexible material, the teeth of the pinion being formed vertically, the inclined teeth of the rack being bent and stood up substantially vertically and bent rearward when the teeth of the pinion are meshed with those of the rack.

The rack may be molded integrally out of a synthetic resin, so that a rack having a suitable flexibility can be manufactured at a low cost. The teeth of the rack may be stood up via hinge portion respectively and arranged at predetermined intervals, so that the flexure of the teeth of the rack in the standing direction thereof occurs owing to the torsion or bend of the hinge portion. When the thickness of the hinge portion is set smaller than that of the base portion, the torsion or bend of the hinge portion occurs reliably.

When the pinion is meshed with the rack formed as described above, the teeth of the rack stand up along those of the pinion owing to the torsion or bend of the hinge portion. During this time, stress works in the direction in which the teeth of the rack return to their original inclined positions. As a result, the teeth of the rack and those of the pinion maintain a contacting state without play therebetween at all times, so that a backlash does not occur.

The electronic device provided with a rack and a pinion, formed as described above can be used as a disk device provided with a pickup for reading or writing information from or into the recording medium, a toy provided with a driving unit such as a motor, or a timepiece having a long hand and a short hand.

### BRIEF DESCRIPTION OF THE DRAWING

FIG. 1 is a plan view showing the construction of an inner portion of a disk device in an embodiment of the present invention;

FIG. 2 is a perspective view showing a rack used for the disk device;

FIG. 3(a) is a front view showing the rack, FIG. 3(b) is a plan view of the rack, and FIG. 3(c) is a side view of the rack;

FIG. 4(a) is a plan view showing the condition of a pinion meshed with the rack, and FIG. 4(b) is a right side view showing the same condition; and

FIG. 5 is a perspective view of another example of the rack.

### DETAILED DESCRIPTION OF PREFERRED EMBODIMENT

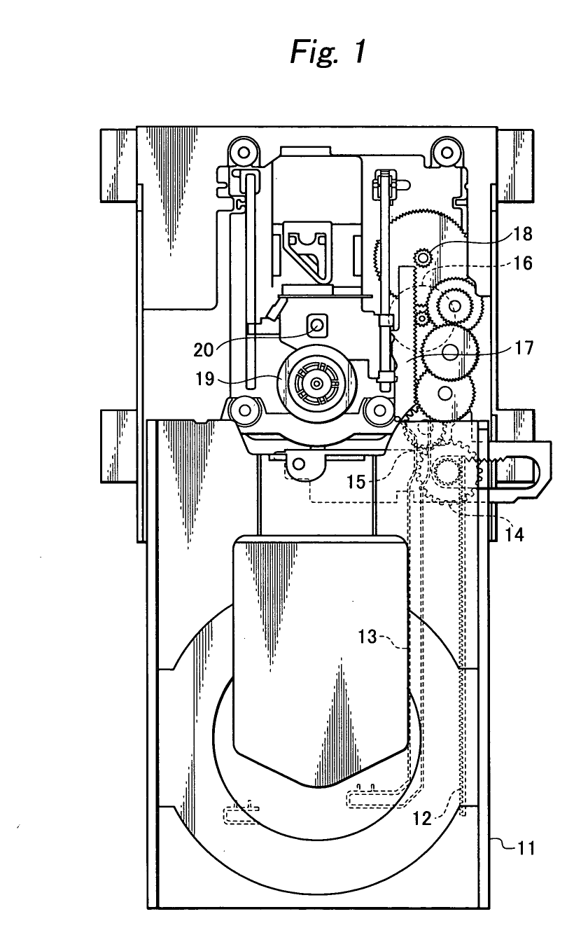

An embodiment of the present invention will now be described in detail with reference to the accompanying drawings. FIG. 1 shows a pickup-carrying disk device in an embodiment of the present invention in an opened state with a tray 11 drawn out. The tray 11 is provided in an upper surface thereof with a circular, shallow recess, in which a disk is fitted and set. A rack 12 is provided extending in the longitudinal direction on the side of a lower surface of the tray, and a substantially L-shaped guide groove 13 is provided along the rack 12. A pinion 14 is meshed with the rack 12, and a cam rod boss 15 is loosely fitted in the guide groove 13.

The pinion 14 is driven to rotate by a motor 16, and the rack 12 and tray 11 are moved back and carried into the interior of the disk device owing to the rotation of the pinion 14. The tray 11 is formed so that the tray 11 can be opened and closed by being moved forward and backward by a predetermined distance.

In the disk device, a traverse unit having a turntable 19 on which a disk is mounted is also provided with a rack 17 additionally. The rack 17 is meshed with a pinion 18 and slid to cause an optical pickup 20, which is used to record information on the disk and reproduce the recorded information, to be moved accurately.

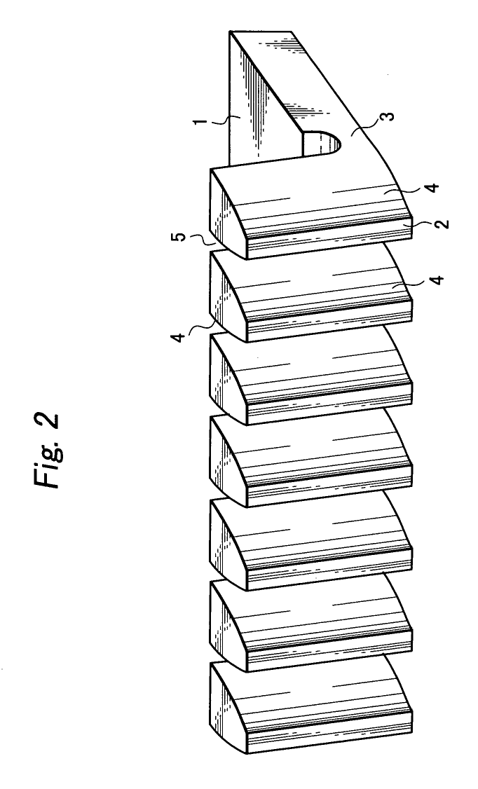

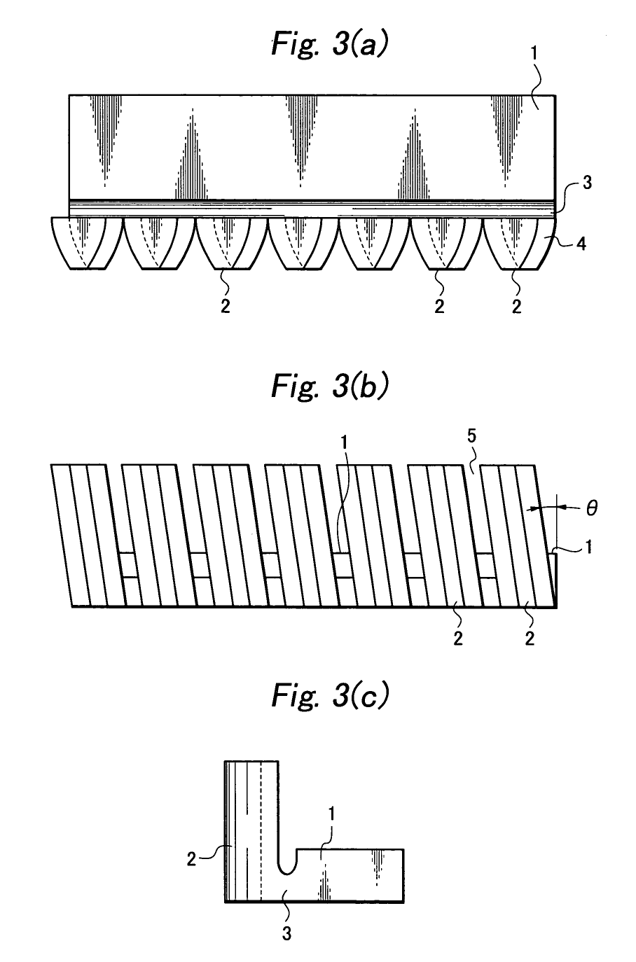

FIG. 2 and FIGS. 3(a) to 3(c) show on an enlarged scale the construction of racks used as the racks 12, 17, which has an elongated plate type base portion 1, a plurality of teeth 2, 2 . . . and hinge portions 3, . . . molded integrally out of a synthetic resin. The teeth 2, 2 . . . are connected respectively to one side section of a base portion 1 via hinge portions 3, 3 . . . , and stand up in an inclined state. The teeth 2, 2 . . . have tooth surfaces 4, 4 curved to a predetermined shape on both sides thereof. Moreover, the teeth 2, 2 . . . are independent of one another, and provided with clearances 5, 5 . . . thereamong. The hinge portions 3 are provided between the base portion 1 and teeth 2, and formed to a greatly constricted shape so that the hinge portions are low in rigidity and easily twisted or bent.

An angle θ of inclination of each of the teeth 2, 2 . . . is small, and may be at a sufficient level at which stress of returning the teeth of the rack to the original inclined direction works when the teeth of the pinion are meshed with those of the rack to cause the hinge 3 to be twisted or bent and put in a vertically deflected state, and at which the contacting state of the teeth 2, 2 . . . with respect to those of the pinion is maintained so that a backlash does not occur (refer to FIG. 3(a)).

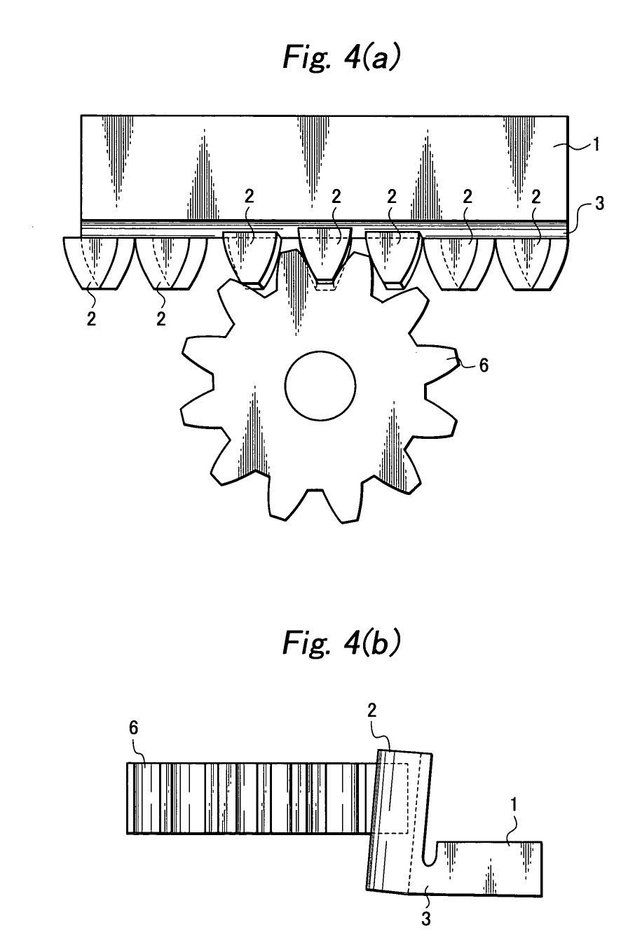

FIGS. 4(a) and 4(b) show the condition of the rack with which the pinion having vertically formed teeth is meshed. When the teeth 6 of the pinion are meshed with upper portions of the teeth 2 of the rack which stand up and are slightly inclined in the direction in which these teeth are arranged, the hinge portion 3 is twisted or bent. As a result, the teeth 2 of the rack stand up substantially vertically, and are pushed by the teeth 6 of the pinion to be inclined slightly in the rearward direction. Since the hinge portion 3 having low strength and rigidity is thus twisted or bent, the teeth 2 of the rack come to be meshed with the teeth 6 of the pinion without causing a backlash to occur. When the pinion is then rotated to cause the teeth of the rack to be disengaged from the teeth 6 of the pinion 6, the teeth 2 return to the original condition in order.

In this embodiment, the hinge portion 3 is formed into a thin and narrowed shape with respect to the base portion 1 so that the hinge portion 3 is distorted and bent easily. The hinge portion 3 may not necessarily be formed to this shape. For example, the hinge portion 3 alone may be more flexible, or a metal plate may be buried in the base portion 1 so as to render the hinge portion relatively easily deformable.

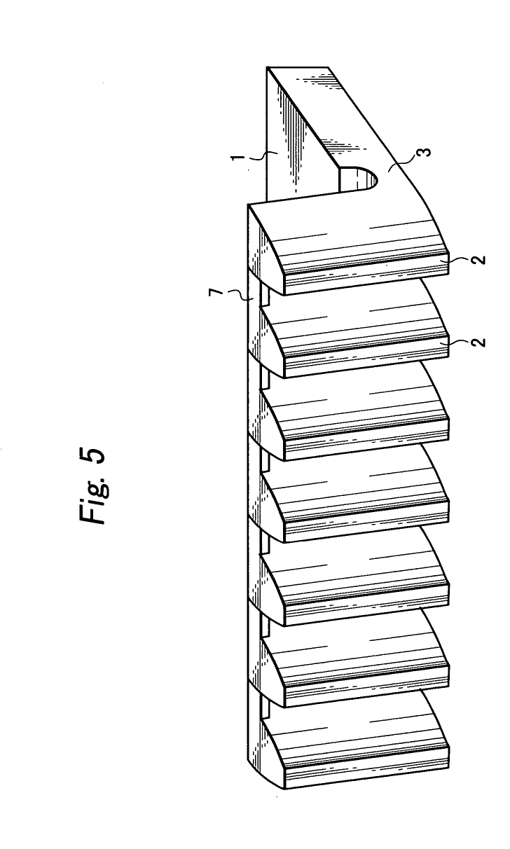

FIG. 5 shows another example of the rack, in which joint portions 7, 7 . . . are interposed among the teeth 2 of the rack without providing clearances 5, 5 . . . among the same. This enables the durability of the rack to be improved. The joint portions 7 are formed out of a soft resin so as to ensure that the inclined teeth 2, 2 stand up substantially vertically when these teeth are meshed with those of the pinion.

According to the electronic device provided with a rack and a pinion of the present invention formed as described above, when the teeth of the pinion are meshed with those of the rack inclined slightly via clearances thereamong, the teeth of the rack stand up substantially vertically and bent rearward. The teeth of the pinion and those of the rack can thus be meshed with one another without causing a backlash, and it enables an accurate feeding operation.

The teeth of the rack are slightly inclined. Therefore, when these teeth are meshed with those of the pinion, the free ends of the former teeth first come into contact with those of the latter and gradually stand up. When the meshed state then ceases, the teeth of the rack are inclined again, and the free ends of the same teeth necessarily leave the teeth of the pinion at last. Namely, the teeth as a whole are not meshed simultaneously, and the noise ascribed to the meshing of the teeth does not occur, so that a quiet motor driving operation can be carried out.

The teeth of the rack stand up and are deflected rearward in accordance with the distortion and bend of the hinge portion but the deformation of the hinge portion does not cause a delay of an operation of the rack to occur. Therefore, the rotation of the pinion is transmitted accurately, and the positioning of the rack is also carried out correctly. Of course, the existence of the hinge portion does not have any influence upon the lifetime of the rack.

According to the present invention, the angle of inclination of the teeth, the quantity of deflection of the teeth in the direction in which the teeth are arranged, the quantity of deflection of the teeth in the direction of the thickness thereof can be regulated in the designing stage, and the rack can be put in an optimum condition in which a backlash can be eliminated in accordance with the opposed pinion. Therefore, the width of the range of the invention increases.

1. An electronic device provided with a rack and a pinion which constitute a feed unit, wherein the rack includes an elongated plate type base portion, and a plurality of teeth stood up in an inclined state at one side section of the base portion with a predetermined pitch, the base portion and teeth being formed integrally out of a flexible material, the teeth of the pinion being formed vertically, the inclined teeth of the rack being bent and stood up substantially vertically and bent rearward when the teeth of the pinion are meshed with those of the rack.

2. An electronic device according to claim 1, wherein the rack is molded integrally out of a synthetic resin.

3. An electronic device according to claim 1, wherein teeth of the rack are stood up via a hinge portion respectively and arranged at predetermined intervals.

4. An electronic device according to claim 3, wherein the hinge portion is formed to a thickness smaller than that of the base portion.

5. An electronic device according to claim 1, wherein the electronic device is a disk device provided with a turntable for rotating a recording medium, and a pickup for carrying out reading of information or writing of information from or into the recording medium.

6. An electronic device according to claim 1, wherein the electronic device is a toy provided with a driving unit such as a motor.

7. An electronic device according to claim 1, wherein the electronic device is a timepiece provided with a long hand and a short hand.

8. An electronic device according to claim 2, wherein the electronic device is a disk device provided with a turntable for rotating a recording medium, and a pickup for carrying out reading of information or writing of information from or into the recording medium.

9. An electronic device according to claim 3, wherein the electronic device is a disk device provided with a turntable for rotating a recording medium, and a pickup for carrying out reading of information or writing of information from or into the recording medium.

10. An electronic device according to claim 4, wherein the electronic device is a disk device provided with a turntable for rotating a recording medium, and a pickup for carrying out reading of information or writing of information from or into the recording medium.

11. An electronic device according to claim 2, wherein the electronic device is a toy provided with a driving unit such as a motor.

12. An electronic device according to claim 3, wherein the electronic device is a toy provided with a driving unit such as a motor.

13. An electronic device according to claim 4, wherein the electronic device is a toy provided with a driving unit such as a motor.

14. An electronic device according to claim 2, wherein the electronic device is a timepiece provided with a long hand and a short hand.

15. An electronic device according to claim 3, wherein the electronic device is a timepiece provided with a long hand and a short hand.

16. An electronic device according to claim 4, wherein the electronic device is a timepiece provided with a long hand and a short hand.
